(19) United States
(12) Patent Application Publication
(10) Pub. No.: US 2023/0374408 A1
(43) Pub. Date: Nov. 23, 2023

(54) Ecologically Friendly Candle Kit

(71) Applicant: Luks Holdings, LLC, Fort Smith, AR (US)

(72) Inventors: Heidi Stojanovic, Fort Smith, AR (US); Sirli Luht, Fort Smith, AR (US); Ivo Luht, Fort Smith, AR (US)

(73) Assignee: Luks Holdings, LLC, Fort Smith, AR (US)

(21) Appl. No.: 18/224,873

(22) Filed: Jul. 21, 2023

Related U.S. Application Data
(63) Continuation of application No. 17/672,503, filed on Feb. 15, 2022.
(60) Provisional application No. 63/149,976, filed on Feb. 16, 2021.

(51) Int. Cl. C11C 5/00

(52) U.S. Cl. CPC C11C 5/004; C11C 5/006; C11C 5/008

(57) ABSTRACT

A kit for assembling an eco-friendlier and more sustainable alternative to traditional candles, which is also versatile and user-friendly. The candle kit disclosed herein is comprised of entirely or mostly natural granulated candle wax and one or more compatible candle wicks supplied together as a set, in a readily biodegradable, and/or recyclable, sturdy packaging box. In one non-limiting embodiment granulated candle wax is poured into an existing container rather than being offered pre-molded and stuck to a candle container like traditional candles. One or more of the wicks included in the product can be inserted directly into the wax particles by the consumer to complete the candle.

### CROSS-REFERENCE TO RELATED APPLICATION

This application is a continuation of prior application Ser. No. 17/672,503, filed Feb. 15, 2021, entitled “Ecologically Friendly Candle Kit,” which claims the benefit of U.S. Provisional Patent Application No. 63/149,976 filed Feb. 16, 2021, the disclosures of which are incorporated herein by reference in their entirety.

### TECHNICAL FIELD

The present invention relates to environmentally friendly candles, more particularly to methods of making natural granulated candles, compositions of natural granulated candles, and advantages of granulated candles over traditional candle products.

### BACKGROUND OF THE INVENTION

Candles are a popular item used for home decor, especially container candles that come pre-formed and stuck to a container of some sort, most typically made out of glass or metal. Most container candles are manufactured by heating one or more types of candle wax in a vessel of some sort to melt the wax, blending these together with dyes, fragrances, essential oils, and other additives, and then pouring these into individual containers or molds to solidify.

These container candles are sold to the consumer as a solid block of colored and/or scented wax formed within a container. Most candle containers are made of glass, which is not biodegradable but is readily recyclable. However, in some geographic regions, glass is not collected for recycling, and even where it is, many consumers do not recycle candle containers since the leftover wax stuck to the glass is inconvenient to remove. Traditional candles are also often offered in packaging made from non-renewable resources such as plastic that are non-biodegradable or even recyclable. For these reasons, there is a need for an ecologically friendlier alternative to traditional candles, which the present invention offers.

Other granulated candle products are offered on the market delivered to the consumer in soft, plastic packaging that is not designed with user-friendliness or eco-friendliness in mind. The present invention describes an improvement over existing granulated candles that are not packaged in biodegradable or renewable material or designed with user-friendliness in mind.

### SUMMARY OF THE INVENTION

Many of the drawbacks and limitations stated above can be resolved by creating a novel physical form of candle waxes, and a delivery method that is both user-friendly and more sustainable for the environment.

Embodiments of the disclosed invention are directed to candle kits that are made from renewable resources, delivered in biodegradable and recyclable packaging, and designed to not create any non-biodegradable waste that would end up in landfills. In various embodiments of the disclosed invention, a fully sustainable candle kit and a method of creating said candle kit are provided.

Regarding the sustainable candle, the kit is comprised of granulated candle wax and compatible candle wicks supplied together as a set, in a readily biodegradable, and/or recyclable, sturdy packaging box. The candle wax supplied in the granulated form is designed to be burned in this form by the consumer using the included wicks in a wide range of optional containers.

In some embodiments, the granulated candle wax is entirely composed of one or more natural waxes.

In some embodiments, where the granulated candle wax is entirely composed of one or more natural waxes, these waxes are selected from the group comprising of soy wax, palm wax, beeswax, or purified components of these such as myristic acid, palmitic acid, stearic acid, oleic acid, palmitoleic acid, Triacontanyl palmitate, palmitate, palmitoleate, oleate esters or combinations of these or other similar materials.

In some embodiments, the granulated candle wax is made from beeswax.

In some embodiments, the granulated candle wax is made from palm wax.

In some embodiments, the granulated candle wax is made from soy wax.

In some embodiments, the granulated candle wax contains a minority portion of paraffin wax.

In some embodiments, different waxes can be blended in a liquid state before creating the granules. This method results in individual granules that contain more than one wax type.

In some embodiments, different wax types can be mixed together in the solid form to create various wax granule blends.

In some embodiments, the granulated candle wax has an average particle diameter of 0.001 millimeters to 20 millimeters.

In some embodiments, the granulated candle wax has an average particle diameter of 0.01 millimeters to 10 millimeters.

In some embodiments, the granulated candle wax has an average particle diameter of 0.1 millimeters to 5 millimeters.

In some embodiments, the granulated candle wax is colored with one or more dyes or pigments.

In some embodiments, the granulated candle wax is scented with essential oils or candle fragrances.

In some embodiments, the granulated candle wax is mixed with one or more appearance enhancing materials such as glitters and/or reflective particles.

In some embodiments, the granulated candle wax is mixed with other performance-enhancing additives such as essential oils or other additives to accomplish properties such as insect repellence, aromatherapy, relaxation, wakefulness, or other physical or psychological benefits.

In some embodiments, granulated waxes enhanced with different additives can be mixed for aesthetic or functional reasons.

In some embodiments, the one or more wicks included with the candle kit are made from entirely renewable components, including a natural core and a natural wax exterior.

In some embodiments, the one or more wicks included with the kit have a natural core with a wax exterior made partially or entirely of paraffin wax.

In some embodiments, the candle kit is packaged in a box that is entirely made from biodegradable materials.

In some embodiments, the packaging box is sturdy enough that it does not get deformed when the granulated wax beads are poured from the packaging box into a secondary container.

In some embodiments, the candle packaging box is made from paper or cardboard with a minimum thickness of 0.5 millimeters.

In some embodiments, the candle packaging box contains a biodegradable separator that keeps the wicks separate from the wax granules such as a piece of cardboard, paper, natural compressed pulp, box, envelope, or the like.

In some embodiments, the candle packaging box contains a secondary containment vessel such as a box, envelope, string, folded paper or cardboard or the like that holds the wicks bundled together.

In one non-limiting embodiment there is provided an ecologically friendly candle kit that includes a mostly or entirely recyclable and/or biodegradable packaging container comprising entirely or mostly natural granulated candle wax and one or more mostly or entirely natural wicks.

In a different non-restrictive version, there is provided an ecologically friendly candle kit a sturdy yet eco-friendly packaging container that has a plurality of granulated candle wax beads made from selected from the group consisting of beeswax, soy wax, or palm wax, where the types of granulated wax particles are different from each other by a characteristic selected from the group consisting of particle size, color, scent, additive types, a and combinations of these, and one or more compatible candle wicks.

In yet another non-limiting embodiment there is provided an ecologically friendly scented wax melt kit having entirely or mostly natural, scented, granulated candle wax selected from the group consisting of palm wax, beeswax, soy wax, or the purified components of these selected from the group consisting of myristic acid, palmitic acid, stearic acid, oleic acid, palmitoleic acid, Triacontanyl palmitate, palmitate, palmitoleate, oleate esters, and combinations of these, and a mostly or entirely recyclable and/or biodegradable packaging container sturdy enough to retain its shape when the granulated candle wax is removed from it.

### BRIEF DESCRIPTION OF THE DRAWINGS

The objects and advantages of the disclosed invention will be further appreciated in light of the following detailed descriptions and drawings in which:

FIG. 1 is an illustration of a granulated candle kit described in the disclosed invention as used by the end consumer.

FIG. 2 is an illustration of a granulated candle kit as described in the disclosed invention, showing the granulated candle wax, wicks in a secondary containment, biodegradable separator between the wicks and the wax, all enclosed in a biodegradable yet sturdy box.

FIG. 3 is an illustration of an example of a biodegradable wick containment method, in this case a folded paper, which is included in the candle kit.

FIG. 3A is an illustration of an example of a biodegradable wick containment method, in this case a paper envelope, which is included in the candle kit.

FIG. 3B is another illustration of an example of a biodegradable wick containment method, in this case a paper or cardboard box, which is included in the candle kit.

FIG. 3C is yet another illustration of an example of a biodegradable wick containment method, in this case a natural string tied around the bundle of wicks, which is included in the candle kit.

FIG. 3D is yet another illustration of an example of a biodegradable wick containment method, in this case a strip of paper wrapped around the bundle of wicks, which is included in the candle kit.

FIG. 4 is an illustration of an example of a possible granulated candle kit containing granulated candle wax beads and wicks bundled together with a natural string.

FIG. 5 is an illustration of a granulated candle kit as described in the disclosed invention, showing more than one type of granulated candle wax blended together, wicks in a secondary biodegradable container such as a paper envelope or box, all enclosed in a biodegradable yet sturdy box.

FIG. 5A is an illustration of an example of a granulated candle kit, showing more than one type of granulated candle wax layered on top of each other, and wicks in a secondary biodegradable container such as a paper envelope or box, all enclosed in a biodegradable yet sturdy box.

FIG. 5B is an illustration of an example of a granulated candle kit, showing more than one type of granulated candle wax separated from one another vertically, and wicks bundled together with a natural string, all enclosed in a biodegradable yet sturdy box.

FIG. 6 is an illustration of an example of a possible granulated candle kit containing granulated candle wax beads, one or more wicks, product documents, and a biodegradable separator tray that keeps the wicks and documents separate from the granulated wax beads.

### DETAILED DESCRIPTION OF THE INVENTION

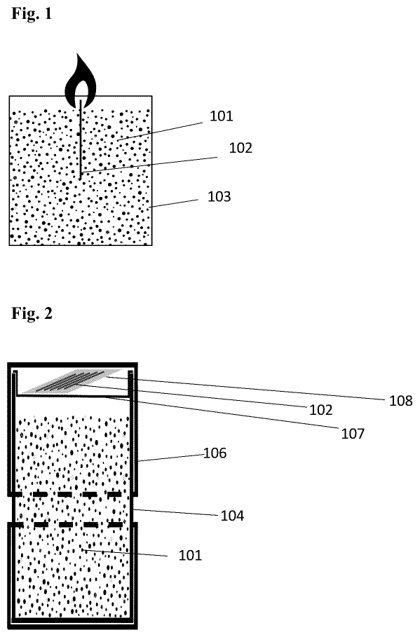

It will be appreciated that FIGS. 1-2, 3A-3D, and 4-5, 5B, and 6 are schematic and that the various elements are not necessarily to scale or proportion, and that many details have been removed or simplified for clarity, and thus the methods and compositions are not necessarily limited to the embodiments depicted in the Figures.

The articles described herein are useful in providing an eco-friendlier and more sustainable alternative to traditional candles, which is also more versatile and user-friendly compared to existing candle products. This invention describes a candle kit that is comprised of granulated candle wax and compatible candle wicks supplied together as a set, in a readily biodegradable, and/or recyclable, sturdy packaging box. The intended use for this kit is for the granulated candle wax to be poured into an existing household container rather than being offered pre-molded and stuck to a candle container. One or more of the wicks included in the product can be inserted directly into the wax particles by the consumer to complete the candle.

As used herein, the terms “eco-friendly” and “sustainable” are used to refer to the fact that the product in one or more ways has less negative impact on the environment compared to the traditional alternatives. This can either have to do with the composition of the materials used to create the product, such as using renewable, plant- or animal-based materials, or based on the end-of-life impact this product has compared to traditional candles, namely not leaving behind non-biodegradable and/or non-recyclable components after use.

Traditional candle products comprise of natural or paraffin-based candle wax or wax blends that are pre-melted and formed into a candle container made most often from glass, ceramic or metal. Traditionally, the candle wax is heated until it melts, then poured into a candle container with the wick already inserted into the container. As the wax cools, the wax solidifies around the wick and against the candle container, making the wick and container physically stuck to the candle wax. When the consumer burns these traditional candles, some wax almost always remains stuck to the container during normal use, and therefore the container is not easy to clean from the wax once the candle is no longer usable, leaving the candle container impractical to reuse or recycle.

As shown in FIG. 1, the present invention describes an ecologically friendly and biodegradable alternative to traditional container candles, which includes burning candle wax in granulated form 101 with a wick 102 inserted directly into the wax granules 101 in a wide range of optional containers 103. FIG. 1 represents the product as used by the final consumer, not the product as supplied itself.

As shown in FIG. 2, the candle kit as delivered to the consumer is comprised of granulated candle wax 101 and compatible candle wicks 102 supplied together as a set, in a readily biodegradable, and/or recyclable, sturdy packaging box 104. The packaging box 104 is sturdy enough to hold its shape when pouring the wax particles from the box into a household container 103 to form a candle. One or more of the wicks 102 included in the product can be inserted directly into the granulated wax particles 101 by the consumer to complete the candle. The candle is therefore burned in the granulated form, and only the portion of the granulated wax in close proximity to the burning wick melts as the final product is used by the consumer.

After a period of burning the candle, only a small portion that is closest to the wick 102 of the granulated wax 101 is consumed or melted, leaving most of the wax free-flowing, and easily accessible to transfer to another container 103 for reuse. After allowing the melted portion to cool, the user can grab the top of the wick 102 and lift the wick out of the remaining wax granules 101. Since the melted wax granules 101 stick to the wick 102 as the wax pool cools, the entire melted portion of the wax sticks to the wick 102 and is removed as the wick 102 is lifted. The remaining, unmelted wax granules 101 can be recovered and reused as brand new, or the container 103 can be refilled with new granules 101 to make it brand new again, making it less wasteful and more user-friendly compared to traditional candles. Further, the recovered non-melted granulated wax 101 can optionally be blended with other granulated wax(es) and/or other materials, such as fragrances or reflective particles, to form a new candle with different shape, fragrance, color and overall appearance. The fragrance may be imparted by the inclusion of one or more scent additives including, but not necessarily limited to, essential oils, natural fragrances, and/or synthetic fragrances.

The granulated candle wax 101 is preferably made either entirely or at least mostly from one or more natural waxes either plant- or animal-based. “Natural” is defined herein as derived from plants or animals without the addition of man-made materials (e.g., plastics) or petroleum-based materials, regardless of whether the natural wax or other material is changed with respect to physical form. As a non-limiting examples, beeswax formed into spheres or a natural wax infused with a natural fragrance are still natural materials. Natural waxes are defined as derived from plant or animal sources, and are therefore renewable in nature. This is different from petroleum-based waxes, mainly paraffin wax. Some examples of natural waxes include but are not limited to soy wax, palm wax, beeswax, or purified components of these such as myristic acid, palmitic acid, stearic acid, oleic acid, palmitoleic acid, Triacontanyl palmitate, palmitate, palmitoleate, oleate esters or combinations of these or other similar materials. Different waxes can be blended either while creating the granules in the melted form before the granules are created, or different wax granules can be mixed in the solid form to create wax blends. As used herein, the term “mostly” means in one non-limiting embodiment at least 51 wt %; alternatively, at least 75 wt %; alternatively, at least 90 wt %; and in another non-restrictive version at least 95 wt %.

The typical shape of the wax granules 101 used in the present invention is rounded, spherical, oval (ovoid), prismatic, cylindrical, polyhedron, and combinations of these. The shape of the granule is critical for the candle to work properly to enable the wick 102 to be inserted into the granules without the wick deforming or bending when it is inserted into the granules 101.

In some embodiments, the granulated candle wax 101 has an average particle diameter of 0.001 millimeters to 20 millimeters. More preferably, the granulated candle wax particles 101 have an average particle diameter of 0.01 millimeters to 10 millimeters. Even more preferably, the granulated candle wax particles 101 have an average particle diameter of 0.1 millimeters to 5 millimeters.

Optionally, the granulated wax 101 can be scented by adding compatible candle scents, and can be colored by mixing with dyes, or mixed with decorative additives such as glitter or other reflective particles. Additives such as citronella, lemongrass, citrus, cinnamon, lavender, jojoba, coconut, chamomile, rose, rosemary, basil, sage, juniper, cedar, peppermint, spearmint, or other essential oils or additives can be included for properties such as insect repellent, aromatherapy, relaxation, wakefulness, or other physical or psychological benefits.

As shown in FIG. 2, the kit can further contain an eco-friendly separator tray 107 that separates the granulated candle wax 101 from the wicks 102 and other optional product documents 108 such as instructions, brochures or the like that may be included with the kit. The separator tray 107 is made from a biodegradable and/or recyclable material such as molded natural fiber pulp, cardboard, or the like, in one non-limiting embodiment sturdy enough to keep its shape during shipping. The separator tray 107 may be secured at the top of the box 104 by having a lip at the top that sits on top of the box under the lid 106. However, in an alternate non-limiting embodiment the separator tray 107 can be as simple as a flat shape that conforms to the inside cross-section of the packing container 104. The separator tray 107 secures the granulated candle wax 101 in the box during shipping and keeps the wax from discoloring or harming the wicks 102 and product documents 108. The separator tray 107 further helps make the wicks 102 and instructions 108 easily accessible to the consumer as they first open the box 104 rather than risk having these items get buried into the wax granules during shipping. The packaging box 102 preferably further contains a lid 106 made from the same or different biodegradable and/or recyclable material as the rest of the box 104.

The packaging box 104 is preferably made from at least 0.5 mm thick paper or cardboard, which is easily recyclable and/or biodegradable after this package is emptied from the granulated wax particles 101. The preferred but non-limiting shape of the packaging box contains at least one corner for ease of pouring the granulated candle beads 101 into a variety of optional containers. Some non-limiting examples of shapes of the packaging container are a cube, cuboid, cone, pyramid, triangular prism, rectangular prism, pentagonal prism, hexagonal prism, octagonal prism, or cylinder. The packaging box 104 is preferably sized such that they can easily be picked up and poured out of with one hand.

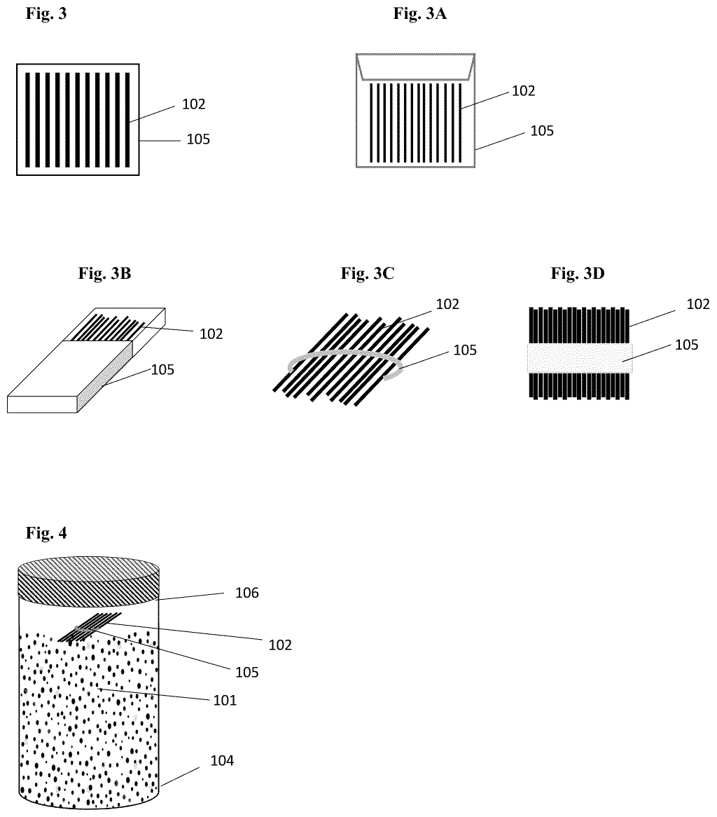

As shown in FIG. 3, the preferred embodiment of the present invention is that wicks 102 compatible with the provided granulated candle particles 101 are included in the kit. As the other components of the product, the wicks 102 are also preferably made all or in part from natural materials such as cotton, hemp, wood, or other natural fibers coated with mostly or entirely natural wax such as palm wax, beeswax, soy wax, purified components of one or more of these waxes, or blends of these with other similar materials. The wicks are preferably pre-cut to specific lengths to make them convenient to use for the consumer, most often between 1-20 cm in length, more preferably 2-15 cm in length, more preferably 3-10 cm in length.

As shown in FIG. 3, the pre-cut wicks 102 are optionally bundled together with some eco-friendly and plastic-free material 105. Some non-limiting examples of this are tying them together into a bundle using a string 105 as shown in FIG. 3C, enclosing in a small box 105 as in FIG. 3B, or envelope 105 as shown in FIG. 3A, or other convenient method for packaging and convenience of use. FIG. 3A, this material is shown as a paper envelope 105. In FIG. 3B the wicks 102 are contained in a paper box 105 that can be opened and closed as the product is used, similarly to a box of matches. In FIG. 3C, the wicks 102 are held together by a string 105 made of natural fibers. In FIG. 3D, the wicks 102 are bundled together using a paper 105 glued to itself, wrapped tightly around the wicks.

As shown in FIG. 4, another embodiment of the present invention is an eco-friendly candle kit that comprises of one or more types of granulated candle wax 101 contained in a sturdy yet eco-friendly box 104, and wicks 102 bundled together by some means of eco-friendly packaging material 105 such as paper or natural string. The product may also contain a cover 106 preferably also made from biodegradable and/or recyclable material.

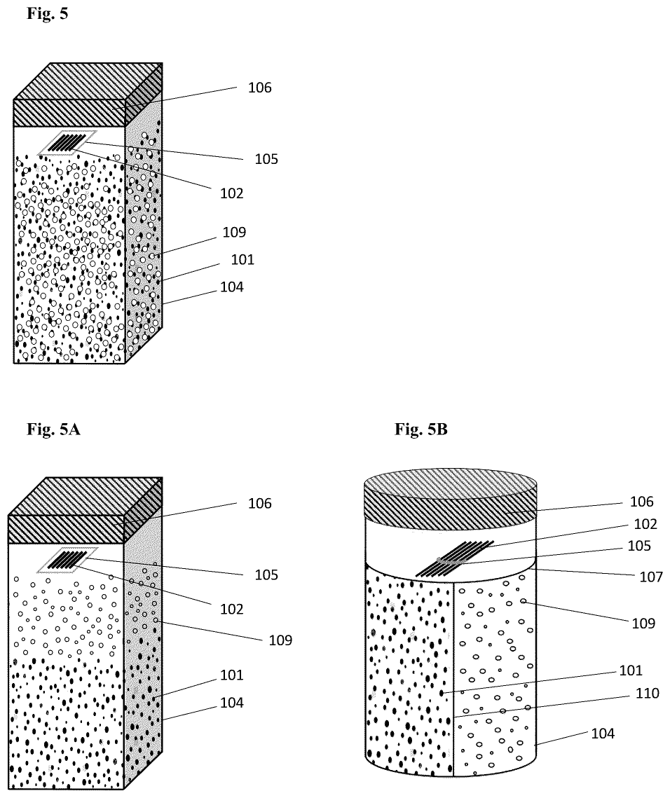

As shown in FIG. 5, another embodiment of this invention describes an eco-friendly candle kit that comprises more than one type of granulated candle wax 101 and 109, blended together to form a mostly uniform mixture of the different types of granules. The granules can differ by one or more different properties, including but not limited to granule size, color, scent, shape, reflective properties, wax type, wax blends, additive types or the like. The candle kit further contains wicks 102 contained together in an eco-friendly packaging material 105, and the entire kit is contained in an eco-friendly yet sturdy packaging box 104.

As shown in FIG. 5A, the different types of granulated candle waxes 101 and 109 can be packaged in the box in two or more layers stacked together for aesthetic or functional reasons. These may be left layered but not physically separated with the purpose of getting loosely blended once poured out of the box by the consumer, potentially forming an aesthetically pleasing swirled pattern of colors or shapes, or serving a functional purpose of only a portion of the granules carrying scents or other functional additives.

As shown in FIG. 5B, another embodiment of the present invention describes another potential delivery method for different granulated wax combinations 101 and 109 in the box 104 by separating them in the box vertically, preferably with a part of the box 110 physically separating the different wax granules from one another. This way the waxes 101 and 109 stay separate during shipping and can be used by consumer either one by one, or by combining different wax types as they please. The product may further contain a separator 107 to keep the candle wax beads 101 and 109 separate from the wicks 102 during shipping.

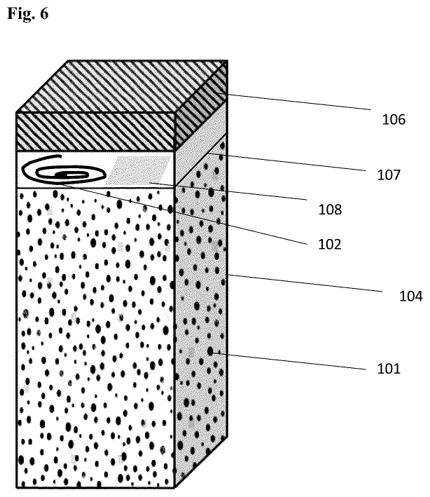

As shown in FIG. 6, another embodiment of the present invention describes an eco-friendly candle kit that contains one or more types of granulated candle wax 101 packaged in a sturdy yet eco-friendly packaging box 104 with one or more pieces of wicks 102 that are separated from the wax 101 by a natural separator tray 107. In this embodiment, it is shown that a wick 102 can be provided in one longer string intended to be cut by the consumer as they prepare their candle. The box may further optionally contain documents 108 such as instructions or product brochure, optionally separated from the wax by the previously described separator tray 107.

Another embodiment of the present invention is to supply the granulated wax 101 and wicks 102 in or with a glass or other recyclable container 103 to be used for burning the candle. The container would be large enough that the melted portion of the wax would not reach the side or bottom of the container as the candle burns, making it easy to replace the wick 102 and refill to make the candle look new. This is an improvement over traditional candles as the container would remain easily recyclable since the melting candle wax is not close enough to the side of the container to stick to this container like it does in traditional candles.

This invention also captures the idea of supplying scented candle granules 101 in a sturdy, recyclable container 104 which may not include wicks. This is to be used as a wax-melt product for scenting a room without needing to light a flame. This is an improvement over current products for wax melts as the granulated form makes it easy to dose in the appropriate amount of candle wax desired by the consumer, and allows for the granulated wax product to be used in a convenient and desirable form for aesthetics, and optionally, to achieve optimal surface-area for scent evolution rate.

In the foregoing specification, the invention has been described with reference to specific embodiments thereof, and has been demonstrated as effective in providing an ecologically friendly candle kit. However, it will be evident that various modifications and changes can be made thereto without departing from the broader scope of the invention as set forth in the appended claims. Accordingly, the specification is to be regarded in an illustrative rather than a restrictive sense. For example, specific packaging containers, natural granulated candle waxes, natural wicks, trays, natural or eco-friendly materials, visually aesthetic additives, fragrance additives, other than those specifically exemplified or mentioned, or in different combinations or proportions, falling within the claimed parameters, but not specifically identified or tried in a particular embodiment, are within the scope of the method and compositions described herein.

The present invention may suitably comprise, consist of or consist essentially of the elements disclosed in the specification and claims, and may be practiced in the absence of an element not disclosed.

There may be further provided an ecologically friendly candle kit comprising, consisting essentially of, or consisting of a mostly or entirely recyclable and/or biodegradable packaging container comprising, consisting essentially of, or consisting of entirely or mostly natural granulated candle wax, and one or more mostly or entirely natural wicks. There may be additionally provided an ecologically friendly candle kit comprising, consisting essentially of, or consisting of a sturdy yet eco-friendly packaging container comprising, consisting essentially of, or consisting of a plurality of granulated candle wax beads made from selected from the group consisting of beeswax, soy wax, or palm wax, where the types of granulated wax particles are different from each other by a characteristic selected from the group consisting of particle size, color, scent, additive types, a and combinations of these, and one or more compatible candle wicks.

Further there may be provided an ecologically friendly scented wax melt kit comprising, consisting essentially of, or consisting of entirely or mostly natural, scented, granulated candle wax selected from the group consisting of palm wax, beeswax, soy wax, or the purified components of these selected from the group consisting of myristic acid, palmitic acid, stearic acid, oleic acid, palmitoleic acid, Triacontanyl palmitate, palmitate, palmitoleate, oleate esters, and combinations of these, and a mostly or entirely recyclable and/or biodegradable packaging container sturdy enough to retain its shape when the granulated candle wax is removed from it.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method of making and using a candle, the method comprising the steps of:
placing wax granules into a container;
inserting a wick into the wax granules in the container;
lighting the wick;
allowing the wick to burn, thereby melting a portion of the wax granules and leaving the remaining wax granules as unmelted wax granules;
extinguishing the wick; and
removing the wick and the melted wax from the container.

2. The method of claim 1 further comprising the step of:
placing additional wax granules into the container with the unmelted wax granules.

3. The method of claim 1 further comprising the steps of:
transferring the unmelted wax granules from the container to a second container;
inserting a second wick into the unmelted wax granules in the second container; and
lighting the second wick.

4. A method of making a reusable candle comprising the steps of:
obtaining a candle kit comprising wax granules and one or more wicks;
placing the wax granules into a first container;
inserting a first wick into the first container, such that the first wick is surrounded by a first portion of the wax granules;
lighting the first wick;
allowing the first wick to burn, thereby changing the first portion of the wax granules into melted wax while leaving a remainder of the wax granules as unmelted wax granules;
extinguishing the first wick;
removing the first wick from the first container;
transferring the unmelted wax granules to a second container;
inserting a second wick into the unmelted wax granules in the second container; and
lighting the second wick.

5. The method of claim 4, wherein the step of removing the first wick from the first container further comprises removing the melted wax with the first wick while leaving the unmelted wax granules in the first container.

6. The method of claim 5 further comprising the step of:
allowing the melted wax to cool before the step of removing the melted wax with the first wick.

7. The method of claim 4 further comprising the step of:
mixing at least a portion of the wax granules with at least one scent additive selected from the group consisting of essential oils, natural fragrances, synthetic fragrances, and combinations thereof.

8. The method of claim 4 further comprising the step of:
mixing at least a portion of the wax granules with at least one visually aesthetic additive selected from the group consisting of dyes, pigments, reflective particles, glitter, and combinations thereof.

9. The method of claim 4 further comprising the step of:
mixing at least a portion of the wax granules with a second type of wax granules selected from the group consisting of soy wax, palm wax, beeswax, the purified components of one or more of these, and mixtures of two or more of these, where the purified components are selected from the group consisting of myristic acid, palmitic acid, stearic acid, oleic acid, palmitoleic acid, triacontanyl palmitate, palmitate, palmitoleate, oleate esters, and combinations of these.

10. The method of claim 4 further comprising the step of:
mixing at least a portion of the wax granules with a natural additive selected from the group consisting of essential oils, citronella, lavender, peppermint, spearmint, lemongrass, cedar, tea tree, lemongrass, jojoba, rose, cinnamon, basil, sage, and combinations thereof.

11. A method of using an ecologically friendly candle comprising the steps of:
placing wax granules into a first container;
inserting a wick into the wax granules in the first container;
lighting the wick;
allowing the wick to burn, thereby changing a portion of the wax granules into melted wax while leaving a remainder of the wax granules as unmelted wax granules;
extinguishing the wick;
transferring the unmelted wax granules to a second container.

12. The method of claim 11, wherein the step of inserting the wick into the wax granules further comprises inserting the wick into the first container at a position such that the melted wax does not reach the side or bottom of the first container as the candle burns.

13. The method of claim 11 further comprising the step of:
selecting the first container based on size, such that the melted wax does not reach the side or bottom of the first container as the candle burns.

14. The method of claim 11 further comprising the step of:
placing additional wax granules into the first container after the step of extinguishing the wick.

15. The method of claim 11 further comprising the steps of:
inserting a second wick into the wax granules in the first container;
lighting the second wick; and
extinguishing the second wick.

16. The method of claim 11 further comprising the steps of:
inserting a new wick into the unmelted wax granules in the second container;
lighting the new wick; and
extinguishing the new wick.

17. The method of claim 11 further comprising the step of:
mixing at least a portion of the wax granules with at least one scent additive selected from the group consisting of essential oils, natural fragrances, synthetic fragrances, and combinations thereof.

18. The method of claim 11 further comprising the step of:
mixing at least a portion of the wax granules with at least one visually aesthetic additive selected from the group consisting of dyes, pigments, reflective particles, glitter, and combinations thereof.

19. The method of claim 11 further comprising the step of:
mixing at least a portion of the wax granules with a second type of wax granules selected from the group consisting of soy wax, palm wax, beeswax, the purified components of one or more of these, and mixtures of two or more of these, where the purified components are selected from the group consisting of myristic acid, palmitic acid, stearic acid, oleic acid, palmitoleic acid, triacontanyl palmitate, palmitate, palmitoleate, oleate esters, and combinations of these.

20. The method of claim 11 further comprising the step of:
mixing at least a portion of the wax granules with a natural additive selected from the group consisting of essential oils, citronella, lavender, peppermint, spearmint, lemongrass, cedar, tea tree, lemongrass, jojoba, rose, cinnamon, basil, sage, and combinations thereof.
